(19) United States
(12) Patent Application Publication
(10) Pub. No.: US 2003/0070100 A1
(43) Pub. Date: Apr. 10, 2003

(54) Computer network activity access apparatus incorporating user authentication and positioning system

(76) Inventor: Marvin J. Winkler, Laguna Hills, CA (US)

Correspondence Address: STETINA BRUNDA GARRED & BRUCKER, 75 ENTERPRISE, SUITE 250, ALISO VIEJO, CA, 92656, US

(21) Appl. No.: 10/101,307

(22) Filed: Mar. 19, 2002

Related U.S. Application Data
(60) Provisional application No. 60/327,631, filed on Oct. 5, 2001.

(51) Int. Cl. H04L 9/32; G06F 15/173

(52) U.S. Cl. 713/202; 701/213; 709/225

(57) ABSTRACT

An internet activity system, authenticating an internet activity by four factors, including something that the client has, something that the client knows, some place that the client is, and something that the client is. A server of a casino provides an internet activity and determines authentication of a user who is requesting access to the internet activity. An internet activity access apparatus is incorporated to provide the information of something that the client has, something that the client knows, some place that the client is, and something that the client is.

### CROSS-REFERENCE TO RELATED APPLICATIONS

The subject application claims the benefit of provisional patent application serial No. 60/327,631 filed Oct. 5, 2001 entitled COMPUTER NETWORK ACTIVITY ACCESS APPARATUS INCORPORATING USER AUTHENTICATION AND POSITIONING SYSTEM

### STATEMENT RE: FEDERALLY SPONSORED RESEARCH/DEVELOPMENT (Not Applicable)

### BACKGROUND OF THE INVENTION

The present invention relates generally to a computer network activity access apparatus, and more particularly to a global computer network, i.e., internet gaming access apparatus that authenticates the user by four factors, including something that the user has, something that user knows, some place that the user is, and something that the user is.

As internet communication has become more and more popular, a multitude of commercial activities are now readily performed on the internet. For example, one can purchase books, equipment, grocery and many other goods and/or services by providing financial information such as the credit/debit card number or the bank account number. Similarly, to provide mobility for amusement and entertainment, internet gaming/gambling has recently been introduced allowing player/users to make wagers at remote locations from gaming casinos. However, to date, nearly all of such internet gaming has been based in locations foreign to the United States. Currently, only a very limited number of states allow internet gaming/gambling under specifically controlled conditions. In all such instances, the age and location of the gaming user must be ascertained and verified prior to accepting any wager. Therefore, how to control the access via ascertaining the age and state location of a user has become a critical requirement for internet gaming applications.

Various approaches for authenticating the identity and thereby the age of a user including inputting the information known to the user, using an access object owned by the user, or comparing personal characteristics have been developed in the prior art. Information known to the user includes passwords, personal identification numbers (PIN) and personal details such as birthday, social security number and the like, objects owned by the user include lock box key entry systems, credit card and/or integrated circuit smart cards, Personal characteristics of a user include biometric characteristics such as finger and thumb prints, hand geometry, voice prints, and/or retinal scans.

The above authentication mechanisms provide various means to attempt to authenticate the identity of the user. However, they fail to provide any mechanism to ascertain the physical location of the authenticated user.

In recent years, the general public has been given access to the NAVSTAR Global Positioning System the United States Air Force (GPS) wherein a GPS receiver receives unique coded signals transmitted by the earth orbiting GPS satellites to derive the geographical position of the receiver. Recently, the costs of such GPS receivers has been substantially reduced allowing their implementation in various consumer products such as automotive vehicles.

Most recently, the use of GPS signals for generating a one-time locational signature to authenticate the location of a user at log-in has been developed as disclosed in U.S. Pat. No. 5,757,916 issued to MacDoran, et al., entitled Method and Apparatus for Authenticating the Location of Remote Users of Networked Computing Systems. However, the MacDoran methodology and apparatus is complicated and costly requiring specific hardware at each user location. Further, the MacDoran method and apparatus is utilized as an alternative to user authentication and is not utilized in combination with other user authentication mechanisms. As such, although the prior art has recognized that GPS can be utilized to enable selected access to a computer system, the prior art is void of any teachings which provide a combined use of user authentication systems/location systems to address the unique concerns of the gaming industry nor any such means which provide a convenient user friendly mechanism for doing the same.

As such, there exists a substantial need in the art for an economical and convenient network access system which authenticates the identity of the user as well as the physical location of the user for gaming applications.

### SUMMARY OF THE INVENTION

To allow only people over a legal age to access a network or internet activity in certain states, the present invention provides an internet activity system that authenticates the identity and geographical location of the user by four factors. The four factors include something that the client has, something that the client knows, some place that the client is, and something that the client is.

The internet activity system of the present invention includes a server provided by a casino and an internet activity access apparatus for authenticating the client each time access to the internet game is attempted. The factor of something that the client has preferably include an access card, such as a smart card, issued to the client by the casino during a registration process. Any person that intends to communicate with the server for access to the internet activity requires the smart card issued by the casino. At the time of logging on to the server, the smart card is inserted into a card reader, which determines the validity of the smart card, for example, whether the smart card is issued by the casino for the purpose of access to the internet activity provided by the server. The card reader also reads and retrieves the information pre-stored on the smart card, including something that the client knows, such as, the user-known information, and something that the client is, that is, the biometric characteristic of the client. The pre-stored information read by the smart card is then sent to the server via a personal computer. The current user has to then input the user-known information to the server via a pin-pad or a keyboard. The access to the internet game is allowed only when the user-known information input by the current user is identical to that pre-stored in the smart card. Otherwise, the access is denied. Regarding the factor of something that the client is, the biometric characteristic of the client is pre-scanned and pre-stored in the smart card at the time of casino registration to the server. When a current user attempts to access the internet game, a biometric scanner is then used to scan and obtain the biometric characteristic of the current user. The scanned biometric characteristic is compared to the one pre-stored in the smart card. Only when the scanned and pre-stored biometric characteristics are identical to each other, the access to the internet game is allowed. Again, both the pre-stored and the scanned biometric characteristics are sent to the server for comparison.

Alternatively, the pre-scanned biometric characteristics of the registered user can also be pre-stored in a database of the server. During authentication, the pre-stored biometric characteristics is retrieved from the database and compared to the biometric characteristic scanned from the current user.

Once the current user passes the examination of the above three factors, that is, once the current user is authenticated to be the registered user, the application at the client end is launched. As mentioned above, the geographical location of the current user has to be authenticated prior to the access of the internet game. Therefore the internet activity access apparatus further incorporates a GPS device for geographical location authentication of the current user. The GPS device includes a GPS sensor to receive an encrypted latitude/longitude message from a GPS satellite. The encrypted latitude/longitude message is then transferred to the server, which then converts the encrypted latitude/longitude message into a geographic location, such as a state of the United States, so as to determine whether such state allows the internet game. If the state allows the internet game, the access is obtained. Otherwise, the access is denied even if the current user has been authenticated.

Accordingly, the gaming system of the present invention includes a server and an internet activity access apparatus. The internet activity access apparatus comprises a smart card, a card reader to check the validity of the smart card and to read the pre-stored information in the smart card, a pin pad or other data input device to key in the client-known information, a biometric scanner to obtain the biometric characteristic of the current user, and a GPS device to receive the encrypted latitude/longitude message of where the logging user currently is. The internet activity access apparatus communicates to the server via a personal computer or a terminal. The personal computer has a monitor, such as a liquid crystal display to monitor the access to the internet game. The pre-stored and input information are sent to the server and compared to each other thereby, while the encrypted latitude/longitude message is converted into a geographical location by the server. Whether the geographical location is located in a states that allow the internet game is determined by the server. That is, the server is responsible for determining the authentication of all the above four factors.

### BRIEF DESCRIPTION OF THE DRAWINGS

These, as well as other features of the present invention, will become more apparent upon reference to the drawings wherein:

FIG. 1 is a block diagram showing gaming system that incorporates an internet gaming access apparatus provided by the invention.

### DETAILED DESCRIPTION OF THE INVENTION

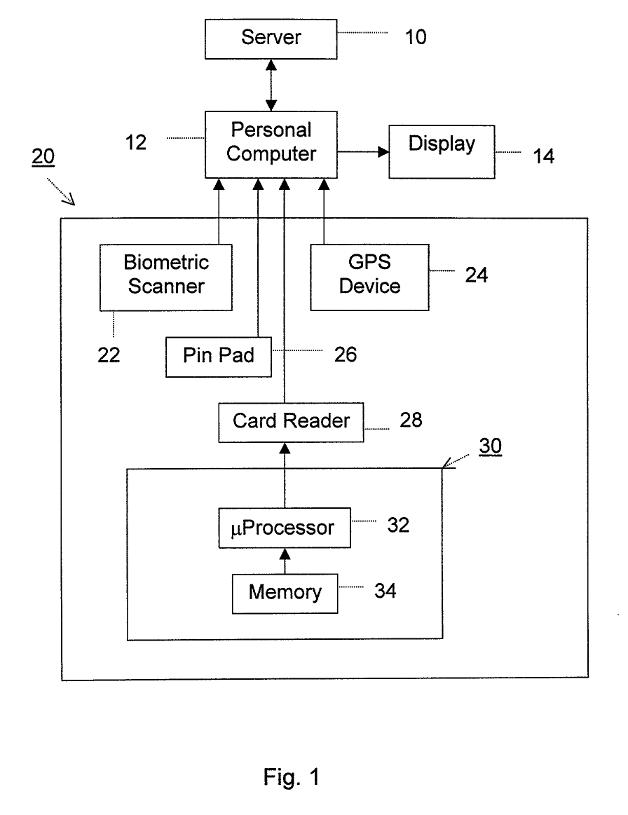

FIG. 1 comprises a block diagram of the computer network and preferably an internet activity system for the present invention specifically directed toward gaming/wager applications. The internet activity system comprises a server 10 that provides the internet activity and an internet activity access apparatus 20 that provides the authentication information of the current user to the server 10. As shown in FIG. 1, a terminal such as a personal computer 12 is used to communicate between the server 10 and the internet activity access apparatus 20.

In one application of the present invention, the server 10 includes a world wide web (www) server located at a casino to provide the internet activity such as gaming/gambling. The www server may be equipped with one or more SSP Cipher servers to provide a plurality of clients (gamblers) logging on at the same time. Before a request for access to the internet activity is granted, the identity and the geographical location of the client(s) have to be authenticated. The internet activity access apparatus 20 provides the identity information and the position information of the client(s) to the server 10 via the personal computer 12, while the server 10 is responsible for determining the authentication. The personal computer 12 is preferably connected to a display 14 such as a liquid crystal display (LCD), so that the authentication process and the access of the internet activity can be monitored thereby.

The present invention preferably authenticates the clients by four factors, including something that the client has, something that the client knows (the user (client)-known information), some place that the client currently is, and something that the client is. In one embodiment of the invention, something that the client has includes an access card, such as a smart card. Something that the client knows, also referred as the user-known information, includes a pin number, a password, or the personal information such as birthday, social security number or other information. Some place that the client is includes the place where the user is at the time of logging on to the server 10. Something that the client is preferably includes the biometric characteristic of the client.

To obtain the information of the above four factors for the current user, the internet activity access apparatus 20 provided by the present invention includes a smart card 30, a card reader 28, a pin pad or a keyboard 26, a biometric scanner 22, and a GPS device 24. The smart card 30 is issued to the client at the time the client registers for gaming activity privileges with the casino. Any person attempting to log on to the server 10 for playing the game must possess a smart card 30 issued by the casino to initiate the access. As shown in FIG. 1, when a user tries to log on to the server 10, the smart card 30 is inserted into a card reader 28 to determine the validity thereof, that is, whether such smart card 30 is issued by the casino for the purpose of access to the internet activity is determined. The server 10 then determines whether the access process will continue or be terminated based on the signal sent from the card reader 28.

Preferably, the smart card 30 includes a microprocessor 32 and a memory 34, in which the user-known information, that is, something that the client knows, is pre-stored at the time of casino registration. When the client tries to access the internet activity, the smart card 30 is inserted into a card reader 28, by which the pre-stored user-known information is read and sent to the server 10 via the personal computer 12. Meanwhile, the current user must provide the user-known information to the server 10 to compare with the pre-stored one. The pin pad 26 is provided for the current user to input the user-known information. As shown in FIG. 1, the pin pad 26 is connected to the server 10 via the personal computer 12. Once the user-known information is provided and input, the server 10 makes a comparison between the pre-stored and currently input user-known information to determine whether the access is continued or terminated. That is, when the input user-known information is identical to the pre-stored one, the access is continued. Otherwise, the access is denied.

In addition to the factors of something that the client has and knows, the present invention further determines access according to another factor of something that the client is. That is, the biometric characteristic that is less perceptible to misidentification is used to authenticate whether the current user is actually the registered user. A biometric scanner is used to scan the current user, so as to obtain a biometric characteristic thereof, while the biometric characteristic of the registered user has been pre-stored in the smart card 30. During the access process, the pre-stored and scanned biometric characteristics of the registered user and the current user are sent to the server 10 via the personal computer 12 to compare with the current input one. Again, the server 10 is then responsible for determining the authentication according to a comparison result between the pre-stored and scanned biometric characteristics of the registered and the current users, respectively. If both of the biometric characteristics are the same, the access is continued. Other, the access is denied. Alternatively, the pre-scanned biometric characteristics of the registered user can be pre-stored in a database of the server 10. During the access process, the pre-stored biometric characteristics of the registered is retrieved from the database for authentication.

Numerous examples of such biometric user identification and user identification systems exist such as those disclosed in U.S. Pat. No. 5,793,881 issued to Stiver, et al., entitled Identification System issued Aug. 11, 1998, and U.S. Pat. No. 6,219,439 B1 issued to Burger on Apr. 17, 2001 entitled Biometric Authentication System, the disclosures of which are expressly incorporated herein by reference. As is known, such biometric identification system utilizes single or multiple characteristic features of the human anatomy as a means of identifying an individual. Recent advancements of the Stiver, et al., identification system utilizes a photographic, topographical map of a user's subcutaneous tissue approximately 3 mm into the user hand and compares it with a stored secure image previously obtained from the user and stored in memory. Such recent advancement is currently being developed by Advanced Biometrics, Inc., the Assignee of Stiver, et al., which biometric system is known as the SSP Solution Suite technology, the disclosure of which is expressly incorporated herein by reference.

In the preferred embodiment, the particular user specific biometric information is obtained from a user by way of the registration procedure at the casino; for instance, a registration procedure at a particular casino offering such internet gaming. In such instance, the user interfaces with the biometric identification device, wherein the specific biometric information of the user is obtained and placed in memory in the server 10 of the casino and optionally within the memory 34 stored within the smart card 20. During such registration procedure, the age of the user will additionally be verified, for instance, by conventional photo identification means, such as a driver's license and/or passport to ensure that the specific user and the user biometric identification information identifies a user over the legal gambling age used in a particular state. Additionally, during such initial user registration, the user can use a biometric scanner 22 at any desired location remote to the casino.

The GPS device 24 is preferably implemented as a chip receiver which is preferably disposed within the smart card 30, the card reader 28, or individually to communicate with the server 10. The GPS device 24 receives unique coded signals transmitted by the earth orbiting GPS satellites. Preferably, the coded signals comprise encrypted and signed latitude, longitude and secure time stamp and are sent to the server 10 via the personal computer at the time of access. The server 10 converts the coded signals into a geographical location and determines whether the geographical location is within an authorized States that allows the internet game. If the geographical location falls within the authorized States, the access to the internet game is allowed provided that the user has been authenticated. If the geographical location of the current user falls in a State that does not allow the internet gaming, the access is denied no matter whether the current user has been authenticated or not.

As the law restricts the age of the user to gamble or access certain kind of internet activity, and as a protection for the user's right, the identity of the user has to be authenticated. Therefore, the present invention authenticating the user by the above three factors provides a more secured to confirm the age of the user. In addition, the current location (state) of the user can be detected. If the state that the current user is located does not allow internet gambling, the access is denied even the current user is identified as the registered one. If the current state allows internet gambling provided that the current is identified as the registered one, the access is permitted. In this way, the entertainment does not have to be limited to a certain place, while the access is securely monitored.

Indeed, each of the features and embodiments described herein can be used by itself, or in combination with one or more of other features and embodiment. Thus, the invention is not limited by the illustrated embodiment but is to be defined by the following claims when read in the broadest reasonable manner to preserve the validity of the claims.

What is claimed is:

1. An internet activity system, comprising:
a server, to provide an internet activity and to determine authentication of a user who is requesting access to the internet activity; and
an internet activity access apparatus, to provide identity and geographical location information of the user to the server for authentication.

2. The internet activity system according to claim 1, wherein the identity information includes an access card issued to the user, a information known to the user pre-stored by the user, and a biometric characteristic pre-scanned from the user.

3. The internet activity access system according to claim 1, wherein the internet activity access apparatus further comprises:
a smart card issued to a registered client by the server at the time registering thereto, wherein an information is pre-stored in the smart card;
a pin pad, to input a user-known information of the user to the server;
a card reader, to read and send the information pre-stored in the smart card to the server;
a biometric scanner, to scan and input a biometric characteristic of the user to the server; and
a GPS device, to receive and input a message that contains latitude, longitude and secure time stamp of the user to the server.

4. The internet activity system according to claim 3, wherein the information pre-stored in the smart card includes the information known to the user.

5. The internet activity system according to claim 3, wherein the information pre-stored in the smart card includes a biometric characteristic of the registered client.

6. The internet activity system according to claim 1, further comprising a personal computer to communicate between the server and the internet activity access apparatus.

7. An internet activity access apparatus, to provide authentication information of a user who requests access to an internet activity provided by a server, comprises:
a smart card issued to a registered client by the server at the time registering thereto;
a pin pad, to input a user-known information of the user to the server;
a card reader, to determine the validity of the smart card, and to read and send information pre-stored in the smart card to the server;
a biometric scanner, to scan and input a biometric characteristic of the user to the server; and
a GPS device, to receive and input a message that contains latitude, longitude and secure time stamp of the user to the server.

8. The internet activity access apparatus according to claim 7, wherein the information pre-stored in the smart card includes a user-known information known to the registered client.

9. The internet activity access apparatus according to claim 7, wherein the information pre-stored in the smart card includes a biometric information of the registered client.

10. The internet activity access apparatus according to claim 7, wherein the server determines whether the access is granted according to the user-known information input by the pin-pad, the biometric characteristic input by the biometric scanner, and a geographical location information converted from the message received by the GPS device.

11. The internet activity access apparatus according to claim 7, wherein the smart card further comprises a microprocessor and a memory in which the information is pre-stored.
